(19) United States
(12) Patent Application Publication
(10) Pub. No.: US 2024/0265813 A1
(43) Pub. Date: Aug. 8, 2024

(54) AERODYNAMIC INSTABILITY INDICATION OF PROXIMATE UAM TRAFFIC SYSTEM AND METHOD

(71) Applicant: ARINC Incorporated, Annapolis, MD (US)

(72) Inventor: Shivashankar Maddanimath Veerayya, Bangalore (IN)

(21) Appl. No.: 18/219,332

(22) Filed: Jul. 7, 2023

(30) Foreign Application Priority Data
Feb. 2, 2023 (IN) 202311006751

(51) Int. Cl. G08G 5/00

(52) U.S. Cl. CPC G08G 5/0021; G08G 5/0013; G08G 5/0069

(57) ABSTRACT

A system for displaying an indication of aerodynamically unstable proximate UAM traffic is disclosed. The system includes at least one display and at least one processor communicatively coupled to the at least one display. The at least one processor may be configured to receive air traffic data associated with at least one proximate aircraft. The air traffic data may include a proximate aircraft's rate of descent, rate of turn, or lateral speed. The at least one processor may be configured to determine that the proximate aircraft is aerodynamically unstable if the proximate aircraft's rate of descent, rate of turn, or lateral speed exceeds a maximum rate of descent, rate of turn, or lateral speed, respectively. The at least one processor may be further configured to generate and output a visual representation of aerodynamic instability to the at least one display.

### CROSS-REFERENCE TO RELATED APPLICATION

The present application claims the benefit under 35 U.S.C. § 119(e) of Indian Application Serial Number 202311006751, filed Feb. 2, 2023, which is incorporated herein by reference in the entirety.

### BACKGROUND

Air traffic density is expected to continue to increase with the advent of urban air mobility (UAM). In general, UAMs are aviation transportation systems that use highly automated aircraft which operate and transport passengers or cargo at lower altitudes within urban and suburban areas, which have been developed in response to traffic congestion. These aircraft are typically characterized by their multiple electric-powered rotors or fans used for lift and propulsion, along with the fly-by-wire systems used to control them.

As the density of traffic for UAMs continues to rise and the margin for error continues to shrink, solutions that extend beyond the current paradigm are needed, which promote shared situational awareness and collaboration among UAMs and their operators.

### SUMMARY

A system is disclosed, in accordance with one or more embodiments of the present disclosure. In some embodiments, the system may include at least one display. In some embodiments, the system may include at least one processor communicatively coupled to the at least one display. In some embodiments, the at least one processor may be configured to receive air traffic data associated with at least one proximate aircraft. The air traffic data may include a proximate aircraft's rate of descent. In some embodiments, the at least one processor may be configured to determine whether the proximate aircraft's rate of descent exceeds a maximum rate of descent. In some embodiments, the at least one processor may be configured to generate a visual representation of aerodynamic instability when the proximate aircraft's rate of descent exceeds the maximum rate of descent. In some embodiments, the at least one processor may be configured to output the visual representation to the at least one display. In some embodiments, the at least one display may be configured to display the at least one visual representation.

A system is disclosed, in accordance with one or more embodiments of the present disclosure. In some embodiments, the system may include at least one display. In some embodiments, the system may include at least one processor communicatively coupled to the at least one display. In some embodiments, the at least one processor may be configured to receive air traffic data associated with at least one proximate aircraft. The air traffic data may include a proximate aircraft's rate of turn. In some embodiments, the at least one processor may be configured to determine whether the proximate aircraft's rate of turn exceeds a maximum rate of turn. In some embodiments, the at least one processor may be configured to generate a visual representation of aerodynamic instability when the proximate aircraft's rate of turn exceeds the maximum rate of turn. In some embodiments, the at least one processor may be configured to output the visual representation to the at least one display. In some embodiments, the at least one display may be configured to display the at least one visual representation.

A system is disclosed, in accordance with one or more embodiments of the present disclosure. In some embodiments, the system may include at least one display. In some embodiments, the system may include at least one processor communicatively coupled to the at least one display. In some embodiments, the at least one processor may be configured to receive air traffic data associated with at least one proximate aircraft. The air traffic data may include a proximate aircraft's lateral speed. In some embodiments, the at least one processor may be configured to determine whether the proximate aircraft's lateral speed exceeds a maximum lateral speed. In some embodiments, the at least one processor may be configured to generate a visual representation of aerodynamic instability when the proximate aircraft's lateral speed exceeds the maximum lateral speed. In some embodiments, the at least one processor may be configured to output the visual representation to the at least one display. In some embodiments, the at least one display may be configured to display the at least one visual representation.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is an exemplary embodiment of a system which may be used to display a visual representation of air traffic, in accordance with one or more embodiments of the disclosure.

FIG. 2 is an exemplary embodiment of a system, in accordance with one or more embodiments of the present disclosure.

FIG. 3 is an exemplary embodiment of a display unit computing device of the system of FIG. 2, in accordance with one or more embodiments of the disclosure.

FIG. 4 is an exemplary embodiment of an aircraft computing device of the system of FIG. 2, in accordance with one or more embodiments of the disclosure.

FIG. 5 is an exemplary embodiment of an aircraft computing device of the system of FIG. 2, in accordance with one or more embodiments of the disclosure.

FIG. 6A is an exemplary embodiment of a method which may be used to determine a proximate aircraft's aerodynamic instability, in accordance with one or more embodiments of the disclosure.

FIG. 6B is an exemplary embodiment of a system which may be used to display a visual representation of a proximate aircraft's aerodynamic instability, in accordance with one or more embodiments of the disclosure.

FIG. 7A is an exemplary embodiment of a method which may be used to determine a proximate aircraft's aerodynamic instability, in accordance with one or more embodiments of the disclosure.

FIG. 7B is an exemplary embodiment of a system which may be used to display a visual representation of a proximate aircraft's aerodynamic instability, in accordance with one or more embodiments of the disclosure.

FIG. 8A is an exemplary embodiment of a method which may be used to determine a proximate aircraft's aerodynamic instability, in accordance with one or more embodiments of the disclosure.

FIG. 8B is an exemplary embodiment of a system which may be used to display a visual representation of a proximate aircraft's aerodynamic instability, in accordance with one or more embodiments of the disclosure.

### DETAILED DESCRIPTION OF THE INVENTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein may be directed to a system (e.g., an Urban Air Mobility (UAM) system, a manned aircraft system, an unmanned aerial system (UAS) (e.g., a remote piloted UAS or an autonomous UAS), or the like) and a method configured to determine whether a proximate aircraft is aerodynamically unstable. In some embodiments, the system may determine aerodynamic instability in a proximate aircraft when its rate of descent exceeds a maximum rate of descent. In some embodiments, the system may determine aerodynamic instability in a proximate aircraft when its rate of turn exceeds a maximum rate of turn. In some embodiments, the system may determine aerodynamic instability in a proximate aircraft when its lateral speed exceeds a maximum lateral speed. In some embodiments, the system may notify one or more UAM pilots of potentially catastrophic situations nearby, which will increase overall safety and situational awareness of the one or more UAM pilots.

In some embodiments, the system may track one or more proximate UAM vehicles using Radar or Automatic Dependent Surveillance-Broadcast (ADS-B) analogue through one or more channels (e.g., one or more different frequency bands, a Data Link, or the like). In some embodiments, the tracked data may be received by at least one processor of the system. In one embodiment, the at least one processor may be configured to receive a notification of aerodynamic instability of a proximate aircraft (e.g., UAM vehicle) via the Radar or ADS-B analogues. In another embodiment, the at least one processor may be configured to derive the aerodynamic instability of a proximate aircraft from the Radar or ADS-B analogues. In some embodiments, the system may include a display. The display may be configured to display an indication of aerodynamic instability of a proximate aircraft.

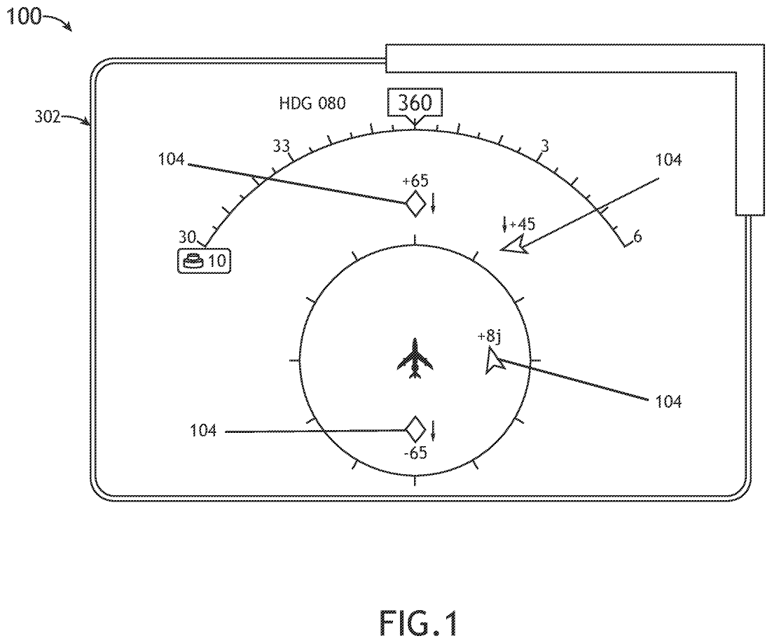

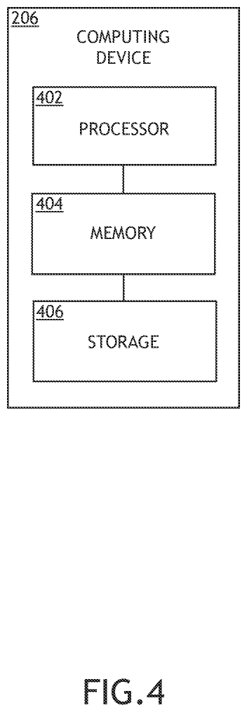

Referring now to FIG. 1, an exemplary embodiment of a system 100 which may be used to display a visual representation of a proximate aircraft 104 is shown, in accordance with one or more embodiments of the present disclosure. In some embodiments, the system 100 may include a display 102 and at least one processor (e.g., 304, 404, and/or 504, as shown in FIGS. 4-6). For example, the at least one processor may be configured to receive data from one or more data sources (e.g., Radar, ADS-B, non-ADS-B data sources, or the like). The at least one processor may be configured to receive air traffic data such as, but not limited to, one or more proximate aircraft 104 and one or more characteristics (e.g., size, altitude, vertical speed, horizontal speed, flight path, make, model, engine type, wing type, or the like) associated with the one or more proximate aircraft 104. By way of another example, the display 102 may be configured to display the air traffic data to a user (e.g., flight crew and/or pilot(s)).

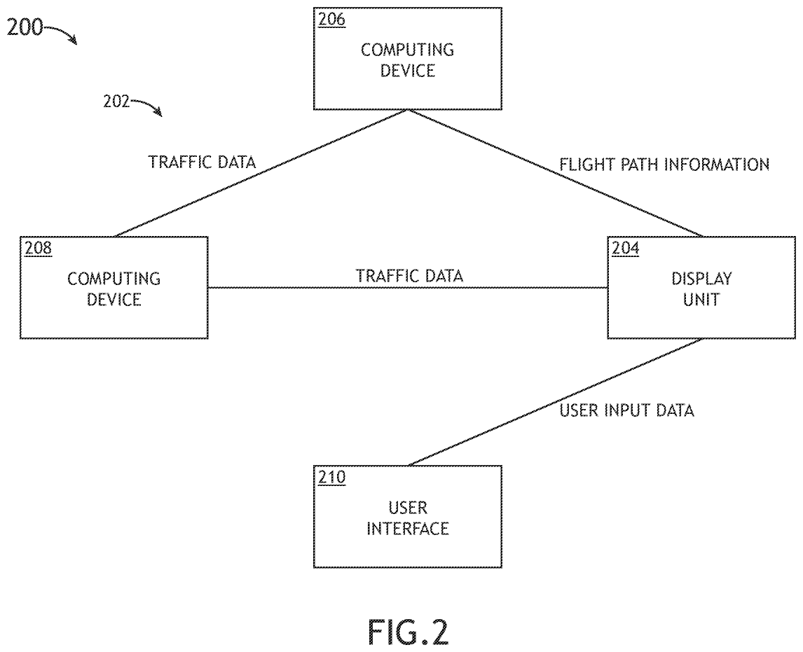

Referring now to FIGS. 2-5, exemplary embodiments of a system 200 are shown, in accordance with one or more embodiments of the present disclosure. In some embodiments, the system 200 may include an aircraft 202, which may include at least one user, at least one display unit computing device 204, at least one aircraft computing device 206, at least one computing device 208 (e.g., at least one automatic dependent surveillance-broadcast (ADS-B) computing device and/or at least one radar computing device), and/or at least one user interface 210, some or all of which may be communicatively coupled at any given time. In some embodiments, the aircraft 202 may include an onboard pilot; in some embodiments, the aircraft 202 may be an Urban Air Mobility (UAM) vehicle (e.g., a manned UAM aircraft, a remote-piloted UAM and/or an autonomous UAM vehicle). In some embodiments, the at least one display unit computing device 204, the at least one aircraft computing device 206, the at least one computing device 208, and/or the at least one user interface 210 may be implemented as a single computing device or any number of computing devices configured to perform (e.g., collectively perform if more than one computing device) any or all the operations disclosed throughout. In some embodiments, the at least one display unit computing device 204, the at least one aircraft computing device 206, the at least one computing device 208, and/or the at least one user interface 210 may be installed in the aircraft 202.

In some embodiments, the user may be a pilot or a crew member. For example, the user may interface with the system 200 via the at least one user interface 210. The at least one user interface 210 may be implemented as any suitable user interface, such as a touchscreen (e.g., of the display unit computing device 204 and/or another display unit), a multipurpose control panel, a control panel integrated into a flight deck, a cursor control panel (CCP) (sometimes referred to as a display control panel (DCP)), a keyboard, a mouse, a trackpad, at least one hardware button, a switch, an eye tracking system, and/or a voice recognition system. By way of another example, the user interface 210 may be configured to receive at least one user input, and then output the at least one user input to a computing device (e.g., 204, 206, and/or 208). In some embodiments, at least one of an image 603, 703, and/or 803 or aircraft traffic may be displayed at least one of autonomously or via a pilot of the aircraft 202 who may be allowed to interface with the user interface 210. For example, such user inputs may be output to the computing device 208 and/or the display unit computing device 204.

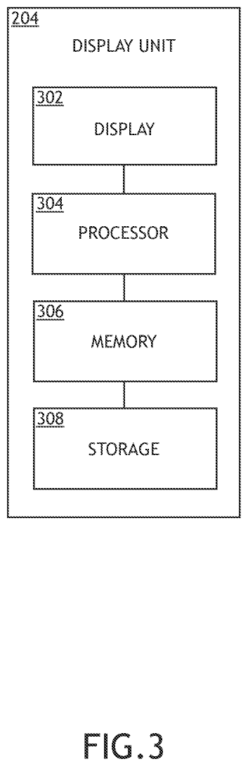

In some embodiments, the display unit computing device 204 may be implemented as any suitable computing device, such as a primary flight display (PFD) computing device and/or a multi-function window (MFW) display computing device. As shown in FIG. 3, the display unit computing device 204 may include at least one display 302, at least one processor 304, at least one memory 306, and/or at least one storage 310, some or all of which may be communicatively coupled at any given time. For example, the at least one processor 304 may include at least one central processing unit (CPU), at least one graphics processing unit (GPU), at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 304 may include a CPU and a GPU configured to perform (e.g., collectively perform) any of the operations disclosed throughout. The processor 304 may be configured to run various software applications or computer code stored (e.g., maintained) in a non-transitory computer-readable medium (e.g., memory 306 and/or storage 310) and configured to execute various instructions or operations. The processor 304 may be configured to perform any or all of the operations disclosed throughout. For example, the processor 304 may be configured to: receive air traffic data (e.g., automatic dependent surveillance-broadcast (ADS-B) data and/or radar data from the computing device 208) associated with one or more characteristics of at least one proximate aircraft 104; compare the received air traffic data to a database of aerodynamic characteristic limit data; determine the aerodynamic stability of the proximate aircraft 104 based at least on the received air traffic data associated with one or more characteristics of the proximate aircraft 104 including, but not limited to, at least one of the aircraft size, flight path, horizontal speed, vertical speed, make, model, engine type, wing type, or altitude of the proximate aircraft 104; generate a visual representation of aerodynamic instability when the proximate aircraft 104 is determined to be aerodynamically unstable; and output the at least one visual representation of aerodynamic instability as graphical data to at least one display 302 for presentation to a user.

In some embodiments, the at least one computing device 208 (e.g., at least one automatic dependent surveillance-broadcast (ADS-B) computing device and/or at least one radar computing device) may be configured to receive aerodynamic stability data from the at least one proximate aircraft 104. For example, the at least one proximate aircraft 104 may be configured to broadcast aerodynamic stability data to other proximate aircraft.

In some embodiments, the at least one aircraft computing device 206 may be implemented as any suitable computing device, such as a flight management system (FMS) computing device, Cockpit Display System, TCAS system, or any avionics system known in the art. The at least one aircraft computing device 206 may include any or all of the elements, as shown in FIG. 4. For example, the aircraft computing device 206 may include at least one processor 402, at least one memory 404, and/or at least one storage 406, some or all of which may be communicatively coupled at any given time. For example, the at least one processor 402 may include at least one central processing unit (CPU), at least one graphics processing unit (GPU), at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 402 may include a CPU and a GPU configured to perform (e.g., collectively perform) any of the operations disclosed throughout. The processor 402 may be configured to run various software applications (e.g., an FMS application) or computer code stored (e.g., maintained) in a non-transitory computer-readable medium (e.g., memory 404 and/or storage 406) and configured to execute various instructions or operations. The processor 402 of the aircraft computing device 206 may be configured to perform any or all of the operations disclosed throughout. For example, the processor 402 may be configured to: output aircraft data (e.g., FMS data, flight path data, inertial reference unit (IRU) data, flight data, and/or flight computer data) to the display unit computing device 204 and/or the computing device 208.

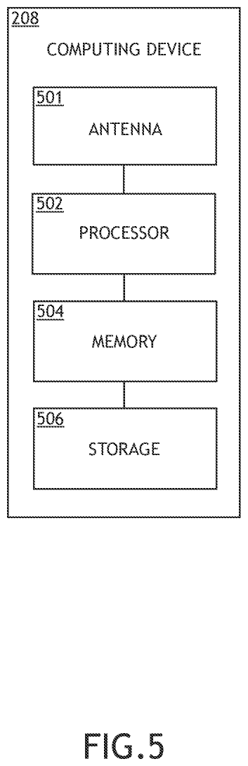

In some embodiments, the at least one computing device 208 may be implemented as any suitable computing device, such as at least one ADS-B receiver computing device and/or at least one radar computing device. The at least one computing device 208 may include any or all of the elements shown in FIG. 5. For example, the computing device 208 may include at least one antenna 501, at least one processor 502, at least one memory 504, and/or at least one storage 506, some or all of which may be communicatively coupled at any given time. For example, the at least one processor 502 may include at least one central processing unit (CPU), at least one graphics processing unit (GPU), at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 502 may include a CPU and a GPU configured to perform (e.g., collectively perform) any of the operations disclosed throughout. The processor 502 may be configured to run various software applications (e.g., an ADS-B application and/or a radar application) or computer code stored (e.g., maintained) in a non-transitory computer-readable medium (e.g., memory 504 and/or storage 506) and configured to execute various instructions or operations. The processor 502 of the computing device 208 may be configured to perform any or all of the operations disclosed throughout. For example, the processor 502 may be configured to: receive air traffic data (e.g., automatic dependent surveillance-broadcast (ADS-B) data and/or radar data); and/or output air traffic data to the display unit computing device 204 and/or the aircraft computing device 206. In some embodiments, the air traffic data is received or is derived from radar data, and for example, wherein the processor 502 may be further configured to track at least the estimated aerodynamic stability for each of the at least one proximate aircraft 104 based at least on the radar data. In some embodiments, for each of the at least one proximate aircraft 104, one or more characteristics of the at least one proximate aircraft 104 including, but not limited to, at least one of the aircraft size, flight path, horizontal speed, vertical speed, make, model, engine type, wing type, or altitude of the proximate aircraft 104 is at least one of received or derived from the air traffic data.

For example, at least one processor (e.g., the at least one processor 304, the at least one processor 402, and/or the at least one processor 502) may be configured to (e.g., collectively configured to, if more than one processor): receive air traffic data (e.g., automatic dependent surveillance-broadcast (ADS-B) data and/or radar data from the computing device 208) associated with one or more characteristics of at least one proximate aircraft 104; compare the received air traffic data to a database of aerodynamic characteristic limit data; determine the aerodynamic stability of the proximate aircraft 104 based at least on the received air traffic data associated with one or more characteristics of the proximate aircraft 104 including, but not limited to, at least one of the aircraft size, flight path, horizontal speed, vertical speed, make, model, engine type, wing type, or altitude of the proximate aircraft 104; generate a visual representation of aerodynamic instability when the proximate aircraft 104 is determined to be aerodynamically unstable; and output the at least one visual representation of aerodynamic instability as graphical data to at least one display 302 for presentation to a user.

At least one processor (e.g., the at least one processor 304, the at least one processor 402, the at least one processor 502, and/or at least one processor located outside of the aircraft 202) may be configured to perform (e.g., collectively perform) any or all of the operations disclosed throughout.

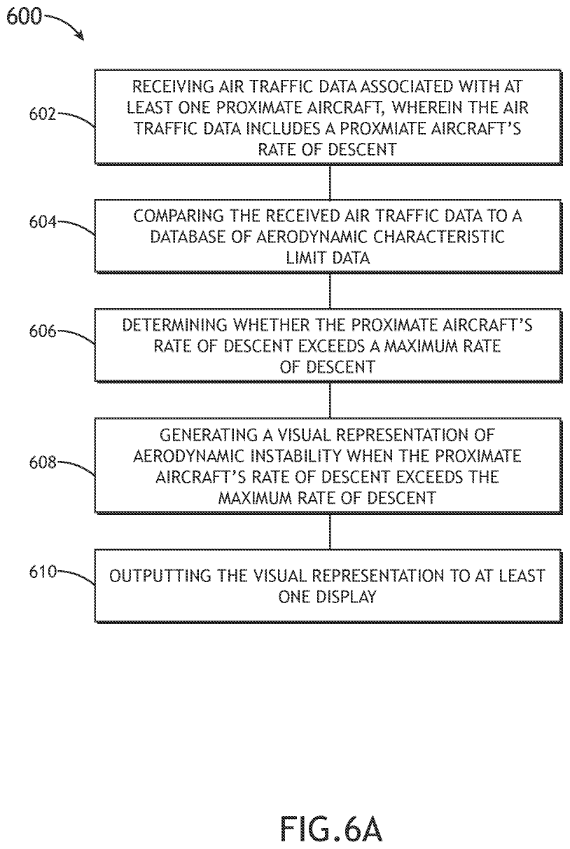

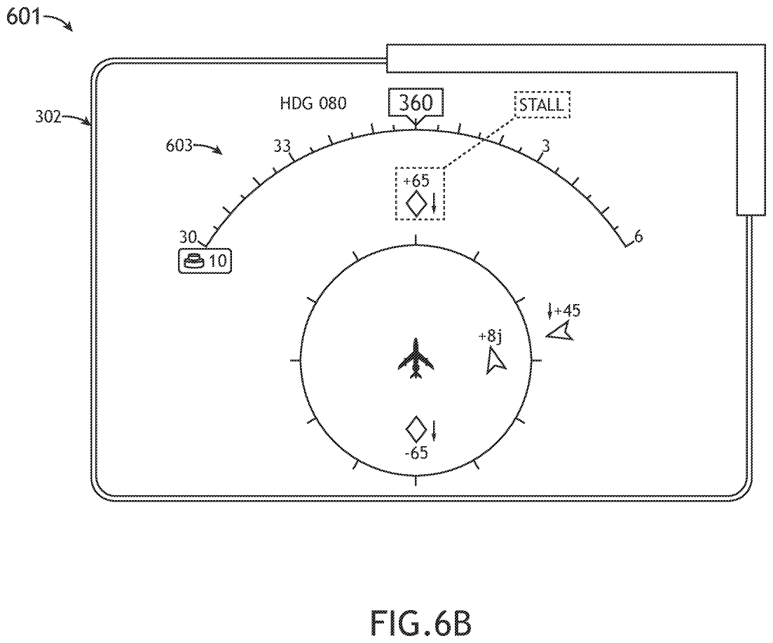

Referring now to FIG. 6A, an exemplary embodiment of a method 600 which may be used to determine the aerodynamic stability of a proximate aircraft 104 is shown, in accordance with one or more embodiments of the disclosure. It is noted herein that the steps of method 600 may be implemented all or in part by the system 601 illustrated in FIG. 6B. It is further recognized, however, that the method 600 is not limited to the system 601 illustrated in FIG. 6B in that additional or alternative system-level embodiments may carry out all or part of the steps of method 600. In some embodiments, the method 600 may include at least one processor (e.g., 304, 402, and/or 502) configured to perform one or more of the following steps. Additionally, for example, some embodiments may include performing one or more instances of the system 601 iteratively, concurrently, and/or sequentially. Additionally, for example, at least some of the steps of the system 601 may be performed in parallel and/or concurrently. Additionally, in some embodiments, at least some of the steps of the system 601 may be performed non-sequentially.

A step 602 may include receiving air traffic data (e.g., automatic dependent surveillance-broadcast (ADS-B) data and/or radar data from the computing device 208) associated with at least one proximate aircraft 104, wherein the air traffic data includes a proximate aircraft's rate of descent.

A step 604 may include comparing the received air traffic data, associated with a proximate aircraft, to a database of aerodynamic characteristic limit data. The characteristic limit data may include at least data associated with a variety of aircraft models and corresponding maximum rates of descent, maximum rates of turn, maximum lateral speeds, critical flight envelope parameters, or other data to help determine when an aircraft (e.g., UAM aircraft) is aerodynamically unstable.

A step 606 may include determining whether the proximate aircraft's rate of descent exceeds a maximum rate of descent for the proximate aircraft 104. It is noted that the maximum rate of descent may vary based on at least one of the proximate aircraft's size, make/model, wing type, engine type, altitude or other characteristic data.

A step 608 may include generating a visual representation of aerodynamic instability when the proximate aircraft's rate of descent exceeds the maximum rate of descent. For example, the visual representation may include at least one of a textual indication (e.g., “STALL”, “TRAFFIC STALL”, or the like) of aerodynamic instability, a Crew Alert Message (CAS), a hyperlinked annunciation, or the like.

A step 610 may include outputting the visual representation to at least one display 302. In some embodiments, the display unit 204 may be configured to indicate aerodynamic instability of at least one proximate aircraft 104 in a variety of ways including, but not limited to, one or more aural and/or visual notifications. The one or more visual notifications may include, but are not limited to, at least one of highlighting (e.g., using one or more different colors) an aerodynamically unstable proximate aircraft 104, textual annunciations (e.g., “STALL”, “TRAFFIC STALL”, or the like), Crew Alert Messages (CAS), hyperlinked annunciations which link to a corresponding proximate aircraft 104, or any other notification method known in the art.

Further, the method 600 may include any of the operations disclosed throughout. It is noted herein the method 600 is not limited to the steps and/or sub-steps provided. The method 600 may include more or fewer steps and/or sub-steps. The method 600 may perform the steps and/or sub-steps simultaneously. The method 600 may perform the steps and/or sub-steps sequentially, including in the order provided or an order other than provided. Therefore, the above description should not be interpreted as a limitation on the scope of the present disclosure but merely an illustration.

Referring now to FIG. 6B, an exemplary embodiment of a system 601 which may be used to display a visual representation of a proximate aircraft's aerodynamic instability is shown, in accordance with one or more embodiments of the disclosure. In some embodiments, the display 302 may include an image 603 of aircraft traffic. The image 603 may include a visual representation of at least one proximate aircraft 104 having an indication of aerodynamic instability. For example, the indication of aerodynamic instability may include a proximate aircraft 104 that has exceeded a maximum rate of descent (e.g., the aircraft is in a condition to stall), causing the aircraft to become aerodynamically unstable.

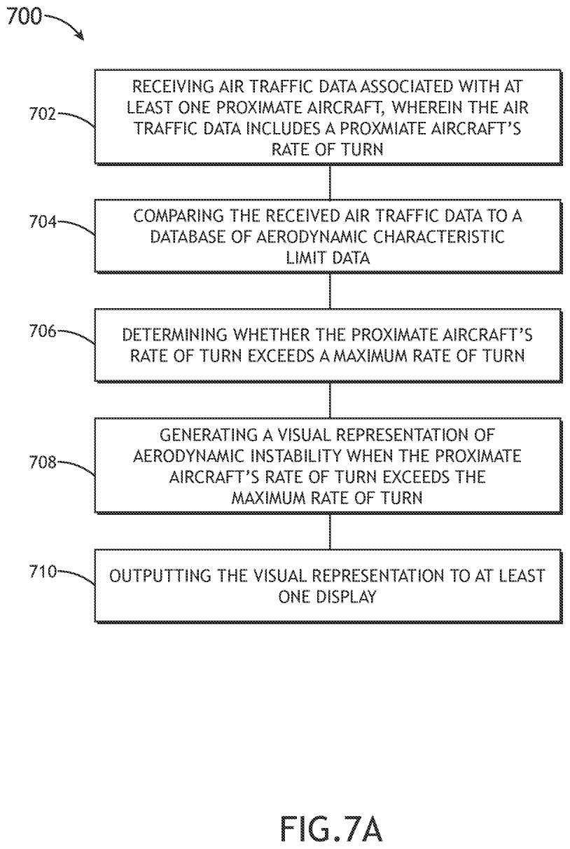

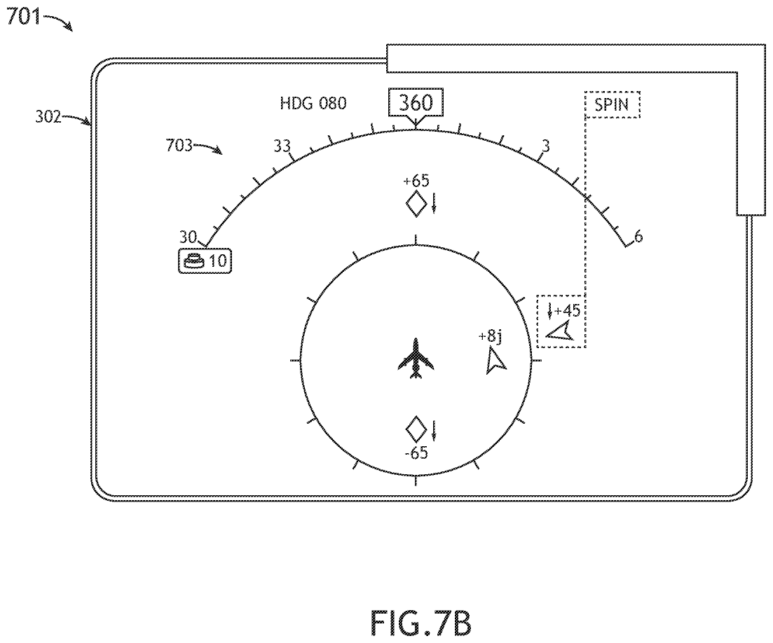

Referring now to FIG. 7A, an exemplary embodiment of a method 700 which may be used to determine the aerodynamic stability of a proximate aircraft 104 is shown, in accordance with one or more embodiments of the disclosure. It is noted herein that the steps of method 700 may be implemented all or in part by the system 701 illustrated in FIG. 7B. It is further recognized, however, that the method 700 is not limited to the system 701 illustrated in FIG. 7B in that additional or alternative system-level embodiments may carry out all or part of the steps of method 700. In some embodiments, the method 700 may include at least one processor (e.g., 304, 402, and/or 502) configured to perform one or more of the following steps. Additionally, for example, some embodiments may include performing one or more instances of the system 701 iteratively, concurrently, and/or sequentially. Additionally, for example, at least some of the steps of the system 701 may be performed in parallel and/or concurrently. Additionally, in some embodiments, at least some of the steps of the system 701 may be performed non-sequentially.

A step 702 may include receiving air traffic data (e.g., automatic dependent surveillance-broadcast (ADS-B) data and/or radar data from the computing device 208) associated with at least one proximate aircraft 104, wherein the air traffic data includes a proximate aircraft's rate of turn.

A step 704 may include comparing the received air traffic data, associated with a proximate aircraft 104, to a database of aerodynamic characteristic limit data. The characteristic limit data may include at least data associated with a variety of aircraft models and corresponding maximum rates of descent, maximum rates of turn, maximum lateral speeds, critical flight envelope parameters, or other data to help determine when an aircraft (e.g., UAM aircraft) is aerodynamically unstable.

A step 706 may include determining whether the proximate aircraft's rate of turn exceeds a maximum rate of turn for the proximate aircraft 104. It is noted that the maximum rate of turn may vary based on at least one of the proximate aircraft's size, make/model, wing type, engine type, altitude or other characteristic data.

A step 708 may include generating a visual representation of aerodynamic instability when the proximate aircraft's rate of turn exceeds the maximum rate of turn. For example, the visual representation may include at least one of a textual indication (e.g., “SPIN”, “TRAFFIC SPIN”, or the like) of aerodynamic instability, a Crew Alert Message (CAS), a hyperlinked annunciation, or the like.

A step 710 may include outputting the visual representation to at least one display. In some embodiments, the display unit 204 may be configured to indicate aerodynamic instability of at least one proximate aircraft 104 in a variety of ways including, but not limited to, one or more aural and/or visual notifications. The one or more visual notifications may include, but are not limited to, at least one of highlighting (e.g., using one or more different colors) an aerodynamically unstable proximate aircraft 104, textual annunciations (e.g., “SPING”, “TRAFFIC SPIN”, or the like), Crew Alert Messages (CAS), hyperlinked annunciations which link to a corresponding proximate aircraft 104, or any other notification method known in the art.

Further, the method 700 may include any of the operations disclosed throughout. It is noted herein the method 700 is not limited to the steps and/or sub-steps provided. The method 700 may include more or fewer steps and/or sub-steps. The method 700 may perform the steps and/or sub-steps simultaneously. The method 700 may perform the steps and/or sub-steps sequentially, including in the order provided or an order other than provided. Therefore, the above description should not be interpreted as a limitation on the scope of the present disclosure but merely an illustration.

Referring now to FIG. 7B, an exemplary embodiment of a system 701 which may be used to display a visual representation of a proximate aircraft's aerodynamic instability is shown, in accordance with one or more embodiments of the disclosure. In some embodiments, the display 302 may include an image 703 of aircraft traffic. The image 703 may include a visual representation of at least one proximate aircraft having an indication of aerodynamic instability. For example, the indication of aerodynamic instability may include a proximate aircraft that has exceeded the maximum rate of turn (e.g., the aircraft is in a condition to spin), which causes the proximate aircraft to become aerodynamically unstable.

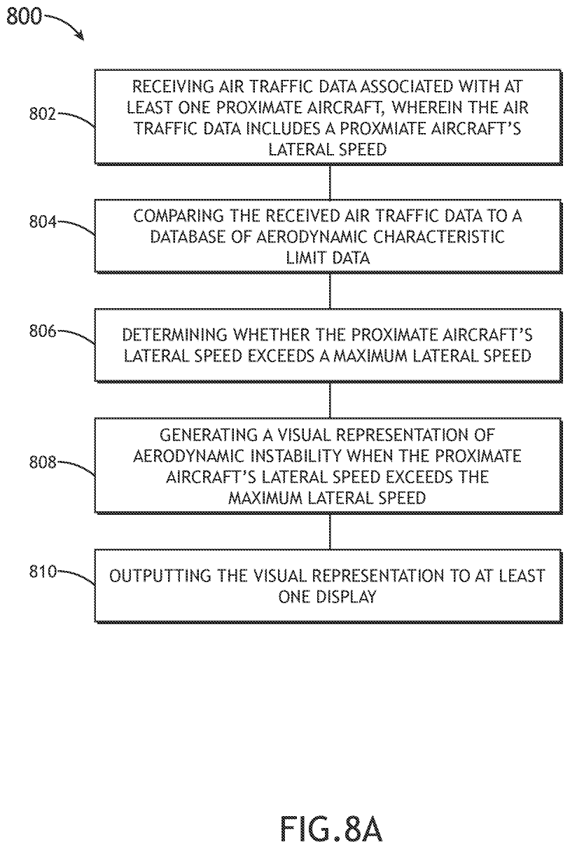

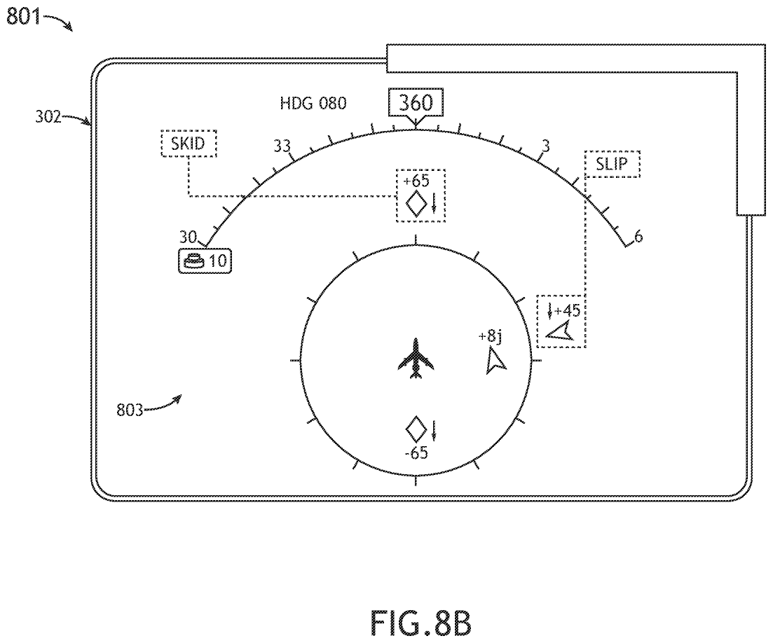

Referring now to FIG. 8A, an exemplary embodiment of a method 800 which may be used to determine the aerodynamic stability of a proximate aircraft 104 is shown, in accordance with one or more embodiments of the disclosure. It is noted herein that the steps of method 800 may be implemented all or in part by the system 801 illustrated in FIG. 8B. It is further recognized, however, that the method 800 is not limited to the system 801 illustrated in FIG. 8B in that additional or alternative system-level embodiments may carry out all or part of the steps of method 800. In some embodiments, the method 800 may include at least one processor (e.g., 304, 402, and/or 502) configured to perform one or more of the following steps. Additionally, for example, some embodiments may include performing one or more instances of the system 801 iteratively, concurrently, and/or sequentially. Additionally, for example, at least some of the steps of the system 800 may be performed in parallel and/or concurrently. Additionally, in some embodiments, at least some of the steps of the system 800 may be performed non-sequentially.

A step 802 may include receiving air traffic data (e.g., automatic dependent surveillance-broadcast (ADS-B) data and/or radar data from the computing device 208) associated with at least one proximate aircraft 104, wherein the air traffic data includes a proximate aircraft's lateral speed.

A step 804 may include comparing the received air traffic data, associated with a proximate aircraft, to a database of aerodynamic characteristic limit data. The characteristic limit data may include at least data associated with a variety of aircraft models and corresponding maximum rates of descent, maximum rates of turn, maximum lateral speeds, critical flight envelope parameters, or other data to help determine when an aircraft (e.g., UAM aircraft) is aerodynamically unstable.

A step 806 may include determining whether the proximate aircraft's lateral speed exceeds a maximum lateral speed for the proximate aircraft 104. It is noted that the maximum lateral speed may vary based on at least one of the proximate aircraft's size, make/model, wing type, engine type, altitude or other characteristic data.

A step 808 may include generating a visual representation of aerodynamic instability when the proximate aircraft's lateral speed exceeds the maximum lateral speed. For example, the visual representation may include at least one of a textual indication (e.g., “SLIP”, “SKID”, or the like) of aerodynamic instability, a Crew Alert Message (CAS), a hyperlinked annunciation, or the like.

A step 810 may include outputting the visual representation to at least one display 302. In some embodiments, the display unit 204 may be configured to indicate aerodynamic instability of at least one proximate aircraft 104 in a variety of ways including, but not limited to, one or more aural and/or visual notifications. The one or more visual notifications may include, but are not limited to, at least one of highlighting (e.g., using one or more different colors) an aerodynamically unstable proximate aircraft 104, textual annunciations (e.g., “STALL”, “TRAFFIC STALL”, or the like), Crew Alert Messages (CAS), hyperlinked annunciations which link to a corresponding proximate aircraft 104, or any other notification method known in the art.

Further, the method 800 may include any of the operations disclosed throughout. It is noted herein the method 800 is not limited to the steps and/or sub-steps provided. The method 800 may include more or fewer steps and/or sub-steps. The method 800 may perform the steps and/or sub-steps simultaneously. The method 800 may perform the steps and/or sub-steps sequentially, including in the order provided or an order other than provided. Therefore, the above description should not be interpreted as a limitation on the scope of the present disclosure but merely an illustration.

Referring now to FIG. 8B, an exemplary embodiment of a system 801 which may be used to display a visual representation of a proximate aircraft's aerodynamic instability is shown, in accordance with one or more embodiments of the disclosure. In some embodiments, the display 802 may include an image 803 of air traffic. The image 803 may include a visual representation of at least one proximate aircraft 104 having an indication of aerodynamic instability. For example, the indication of aerodynamic instability may include a proximate aircraft 104 that has exceeded a maximum lateral speed (e.g., the aircraft is in a condition to slip/skid), which causes the proximate aircraft 104 to become aerodynamically unstable.

As will be appreciated from the above, embodiments of the inventive concepts disclosed herein may be directed to a system (e.g., an aircraft system) and a method configured to, based at least on air traffic data, determine an indication of aerodynamic instability of at least one proximate aircraft.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A system, the system comprising:
at least one display; and
at least one processor communicatively coupled to the at least one display, the at least one processor configured to:
receive air traffic data associated with at least one proximate aircraft, wherein the air traffic data includes a proximate aircraft's rate of descent;
determine whether the proximate aircraft's rate of descent exceeds a maximum rate of descent;
generate a visual representation of aerodynamic instability when the proximate aircraft's rate of descent exceeds the maximum rate of descent; and
output the visual representation to the at least one display,
wherein the at least one display is configured to display the at least one visual representation.

2. The system of claim 1, wherein the at least one processor is further configured to:
generate an aural notification of the proximate aircraft's aerodynamic instability when the proximate aircraft's rate of descent exceeds the maximum rate of descent.

3. The system of claim 1, wherein the air traffic data includes at least one of Automatic Dependent Surveillance-Broadcast (ADS-B) data and Traffic Alert and Collision Avoidance System (TCAS-II) data.

4. The system of claim 1, wherein the air traffic data includes data associated with one or more characteristics of the proximate aircraft, wherein the one or more characteristics of the proximate aircraft include at least one of the proximate aircraft's size, altitude, vertical speed, horizontal speed, flight path, make, model, engine type, and wing type.

5. The system of claim 4, wherein the proximate aircraft's rate of descent is at least one of included in or derived from the one or more characteristics of the proximate aircraft.

6. The system of claim 1, wherein the at least one display is configured for deployment at least one of onboard an Urban Air Mobility (UAM) vehicle and offboard the UAM vehicle.

7. The system of claim 6, wherein the UAM vehicle is an autonomous UAM vehicle, wherein one or more of the at least one processor is located onboard the UAM vehicle.

8. A system, the system comprising:
at least one display; and
at least one processor communicatively coupled to the at least one display, the at least one processor configured to:
receive air traffic data associated with at least one proximate aircraft, wherein the air traffic data includes a proximate aircraft's rate of turn;
determine whether the proximate aircraft's rate of turn exceeds a maximum rate of turn;
generate a visual representation of aerodynamic instability when the proximate aircraft's rate of turn exceeds the maximum rate of turn; and
output the visual representation to the at least one display,
wherein the at least one display is configured to display the visual representation.

9. The system of claim 8, wherein the at least one processor is further configured to:
generate an aural notification of the proximate aircraft's aerodynamic instability when the proximate aircraft's rate of turn exceeds the maximum rate of turn.

10. The system of claim 8, wherein the air traffic data includes at least one of Automatic Dependent Surveillance-Broadcast (ADS-B) data and Traffic Alert and Collision Avoidance System (TCAS-II) data.

11. The system of claim 8, wherein the air traffic data includes data associated with one or more characteristics of the proximate aircraft, wherein the one or more characteristics of the proximate aircraft include at least one of the proximate aircraft's size, altitude, vertical speed, horizontal speed, flight path, make, model, engine type, and wing type.

12. The system of claim 11, wherein the proximate aircraft's rate of turn is at least one of included in or derived from the one or more characteristics of the proximate aircraft.

13. The system of claim 8, wherein the at least one display is configured for deployment at least one of onboard an Urban Air Mobility (UAM) vehicle and offboard the UAM vehicle.

14. The system of claim 8, wherein the UAM vehicle is an autonomous UAM vehicle, wherein one or more of the at least one processor is located onboard the UAM vehicle.

15. A system, the system comprising:
at least one display; and
at least one processor communicatively coupled to the at least one display, the at least one processor configured to:
receive air traffic data associated with at least one proximate aircraft, wherein the air traffic data includes a proximate aircraft's lateral speed;
determine whether the proximate aircraft's lateral speed exceeds a maximum lateral speed;
generate a visual representation of aerodynamic instability when the proximate aircraft's lateral speed exceeds the maximum lateral speed; and
output the visual representation to the at least one display,
wherein the at least one display is configured to display the visual representation.

16. The system of claim 15, wherein the at least one processor is further configured to:
generate an aural notification of the proximate aircraft's aerodynamic instability when the proximate aircraft's lateral speed exceeds the maximum lateral speed.

17. The system of claim 15, wherein the air traffic data includes at least one of Automatic Dependent Surveillance-Broadcast (ADS-B) data and Traffic Alert and Collision Avoidance System (TCAS-II) data.

18. The system of claim 15, wherein the air traffic data includes data associated with one or more characteristics of the proximate aircraft, wherein the one or more characteristics of the proximate aircraft include at least one of the proximate aircraft's size, altitude, vertical speed, horizontal speed, flight path, make, model, engine type, and wing type.

19. The system of claim 15, wherein the at least one display is configured for deployment at least one of onboard an Urban Air Mobility (UAM) vehicle and offboard the UAM vehicle.

20. The system of claim 15, wherein the UAM vehicle is an autonomous UAM vehicle, wherein one or more of the at least one processor is located onboard the UAM vehicle.
